(19) United States
(12) Patent Application Publication
(10) Pub. No.: US 2026/0009441 A1
(43) Pub. Date: Jan. 8, 2026

(54) AUTOMATIC SLACK ADJUSTER ASSEMBLY

(71) Applicant: MADRAS ENGINEERING INDUSTRIES PRIVATE LIMITED, Tamil Nadu (IN)

(72) Inventors: GUNASEKARAN VIVEKANANDAN, Tamil Nadu (IN); SIVARAM SRIRAM, Tamil Nadu (IN)

(73) Assignee: MADRAS ENGINEERING INDUSTRIES PRIVATE LIMITED, Tamil Nadu (IN)

(21) Appl. No.: 18/881,573

(22) PCT Filed: Jul. 7, 2023
(86) PCT No.: PCT/IN2023/050661

§ 371 Date: Jan. 6, 2025

(30) Foreign Application Priority Data
Jul. 8, 2022 (IN) 202241039474

(51) Int. Cl. F16D 65/56

(52) U.S. Cl. CPC F16D 65/56

(57) ABSTRACT

A self-setting automatic slack adjuster assembly as per FIG. 6) comprising a housing (2) which receives a worm shaft (3) in bore (a) of the housing (2) where the hexagon nut of the worm shaft (3) is in the right side of the assembly. A worm wheel (16) is assembled in the bore (b) of the housing (2) which meshes with the worm shaft (3). The bore (b) is perpendicular to the bore (a). The worm wheel (16) is inserted onto the S-cam shaft where S-cam shaft is coaxial with bore (b) of the housing, a clutch worm gear (4) is inserted into the bore (a) from the right side of the housing (2) which meshes with the serrations of the worm shaft (3), a bore (c) is present on the right side of the housing. A ratchet-pinion assembly (14) is inserted into bore (c) of the housing (2), the clutch worm screw (14b) of the ratchet pinion assembly (14) meshes with the clutch worm gear (4) and when the above slack adjuster is installed into the brake assembly, its cover plate assembly (19) faces the brake chamber mounting bracket and thus protected by direct exposure to the dust and water.

We, MADRAS ENGINEERING INDUSTRIES PRIVATE LIMITED, an Indian company, having its place of business at C-6, Industrial Estate, Ambattur, Chennai-600 058. State of Tamil Nadu. India.

The following specification particularly describes the invention and the manner in which it is to be performed.

### FIELD OF INVENTION

This invention relates to an automatic slack adjuster. The invention is an improvement in its design and sealing system of the assembly.

### PRIOR ART

### S-ASA-General Concept

Self-setting Automatic Slack Adjuster (S-ASA) is used to maintain the clearance between brake drum and friction lining. Over continuous brake application, the gap between friction lining and drum inner diameter increases due to wear. The S-ASA is designed to adjust this increased gap. A controlled gap between lining and drum is essential for the effective brake performance. This gap sensing and adjusting mechanism can be achieved by many designs. One such conventional design is explained below.

### Conventional S-ASA Design in Brief

FIG. 1 shows a brake assembly 1L (Left hand side) & 1R (Right hand side) for a drum type brake. S-ASA (1a) is assembled to the S-cam shaft (1b), a brake chamber (1c) is mounted onto the bracket (1d). The S-ASA is connected to the brake chamber via the pin (1e), the pin (1e) is inserted into the hole (h) of S-ASA shown in FIG. 2a. The control arm (21) of S-ASA (1a) is anchored to a fixed member of vehicle (not shown in figure).

S-ASA has two sides-front side and back side, this is shown in FIG. 2 where FIG. 2a represents the front side and FIG. 2b represent the back side of the S-ASA.

The back side of the S-ASA (1a) faces the bracket (1d) when installed in the brake assembly (1L) and the front side of the S-ASA (1a) faces the bracket (1d) when installed in the brake assembly (1R).

FIG. 2, FIG. 3a & FIG. 3b shows a conventional S-ASA assembly comprising a housing (2) which receives a worm shaft (3) in bore (a) of the housing (2) where the hexagon nut (3a) of the worm shaft (3) is in the left side of the assembly. A worm wheel (16) is assembled with 2 O-rings (17 & 15) in the bore (b) of the housing (2) which meshes with the worm shaft (3). A clutch worm gear (4) having serrations is inserted into the bore (b) from the left side of the housing (2) which meshes with the serrations of the worm shaft (3).

A bore (c) is present on the left side of the housing. A ratchet-pinion assembly (14) is inserted into bore (c) of the housing (2), the clutch worm screw (14a) of the ratchet pinion assembly (14) meshes with the clutch worm gear (4).

The front portion of the housing (2) is sealed by the gasket (18) and the cover plate assembly (19) as shown in FIG. 1. The cover plate assembly is screwed with the housing with 7 M4 screws (20).

A spring seat (9), heavy coil compression spring (10) and a spring retainer (11) is inserted from the right end into the bore (a) of the housing (2)

A bearing (5) is inserted into the housing bore (a) from the left side as shown in FIG. 2. An O-ring (6) is placed upon the groove of the worm shaft (3) then a bearing retainer (7) is inserted form the left side of the bore (a). A grease nipple (12) is fitted to the housing (2). A protective cap (8) is assembled to bearing retainer (7) at the left end of the bore (a) which protects the S-ASA from water and dust. The protective cap (8) is anchored to the grease nipple (12), this keeps the protective cap (8) from being missed during brake adjustments.

### SUMMARY OF THE INVENTION

### NEED of Improvement in Existing Design

1. When using conventional design, both left and right side of brake assembly uses same slack adjuster. To achieve the required function S-ASA (1a) has to be assembled in a particular direction onto the cam-shaft, this is shown in FIG. 1 where left and right brake assembly (1L & 1R) uses same S-ASA (1a).

S-ASA has two sides-front side and back side, this is shown in FIG. (2) where FIG. 2a represents the front side and FIG. 2b represent the back side of the S-ASA. The front side of the assembly has more potential leak paths compare to the back side of the assembly.

When the S-ASA is assembled as per FIG. 1, its front side in brake assembly (1L) is directly exposed to the dust and water from the environment. This assembly condition increases the chance of mud and water entry inside the system which can erode the internal parts and thus the performance of S-ASA (1a) can reduce.
2. When worm shaft is rotated in the ‘X’ direction during assembly or for servicing as shown in FIG. 4, Pinion assembly (14) pushes the cover plate (19a) in the direction shown by arrow ‘Y’. Cover plate (19a) which is screwed to housing (2) resists this force.
3. Previously mentioned in point 1 that the S-ASA (1a) has to be assembled from the different direction in left and right brake assembly. This method of assembly is not ideal because it can create a confusion in someone's mind during assembly. The method of assembly should be same in either direction to avoid any kind of confusion.

4. The conventional design is installed for both brake assembly (1L & 1R) in FIG. 1 from the different direction, the stress pattern will be different in SASA (1a) when installed in left side assembly (1L) compare to when installed in right side assembly (1R). This leads to different fatigue life for S-ASA (1a) in brake assembly 1L & 1R. The same design having different fatigue life when installed in left and right cam-shaft does not represent an ideal condition for the brake assembly.

The conventional design carries above mentioned shortcomings which is addressed by this invention. The Main object of this invention is to improve the overall sealing ability of the S-ASA and reduce the potential leaking paths wherever possible. The object of the invention is listed below.

### OBJECT OF THE INVENTION

1. The object is to design such a S-ASA assembly that when installed in vehicle, its potential leak area will not be exposed to dust and water from the environment directly thus protecting the internal components from corrosion.
2. The invention aims to design a S-ASA assembly such that when the worm shaft is rotated (for brake re-setting), the pinion assembly does not push the cover plate thus avoiding a potential leak path.
3. The object is to design a S-ASA assembly which can be assembled in same direction alongside the conventional assembly.
4. This invention aims to provide a S-ASA assembly whose stress pattern will be same as the conventional design, this design will have the similar fatigue life as of conventional assembly.
5. To achieve all the objectives mentioned above, A major design change will be required but this invention aims to accomplish these objectives with a minimal design change, this means that most internal components of S-ASA will be used as it is in the new design or with very minimal changes.

### BRIEF DESCRIPTION OF THE DRAWINGS

FIG. 1 shows a conventional brake assembly with—
Left brake assembly (1L)
Right brake assembly (1R)
S-ASA (1a)
Camshaft (1b & 1g)
Brake chamber (1c)
Brake chamber mounting bracket (1d & 1h)
Pin (1e)
Cam tube (1i & 1j)

FIG. 2, FIG. 3a & FIG. 3b shows a conventional S-ASA (1a) with—
FIG. 2a represents the front side of the S-ASA
FIG. 2b represents the back side of the S-ASA
Body (2)
Worm shaft (3)
Clutch worm gear (5)
Worm shaft O-ring (6)
Bearing retainer (7)
Protective cap (8)
Spring seat (9)
Heavy coil spring (10)
Spring retainer (11)
Grease nipple (12)
Pinion spring (13)
Pinion assembly (14)
Worm wheel O-ring (15 & 17)
Worm wheel (16)
Gasket (18)
Cover plate sub-assembly (19)
Cover plate (19a)
Control arm (21)
Cover plate screw (20)

FIG. 4 shows a conventional S-ASA (1a) with—
FIG. 4a shows a cut section of the S-ASA along the line Z-Z of FIG. 2a
FIG. 4b shows an enlarged view of the cut section 4a

FIG. 5 shows Invention S-ASA
FIG. 5a shows a front side of the Invention S-ASA
FIG. 5b shows a back side of the Invention S-ASA

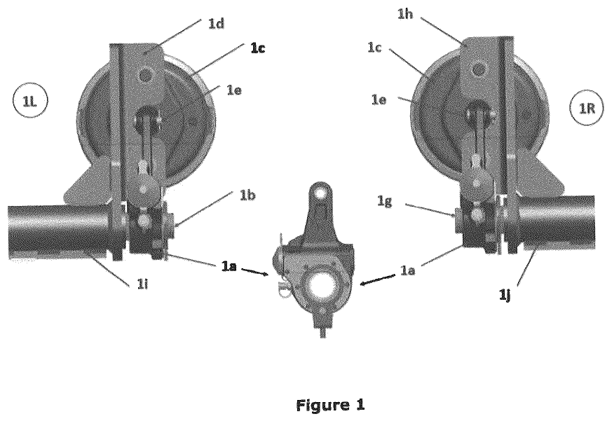

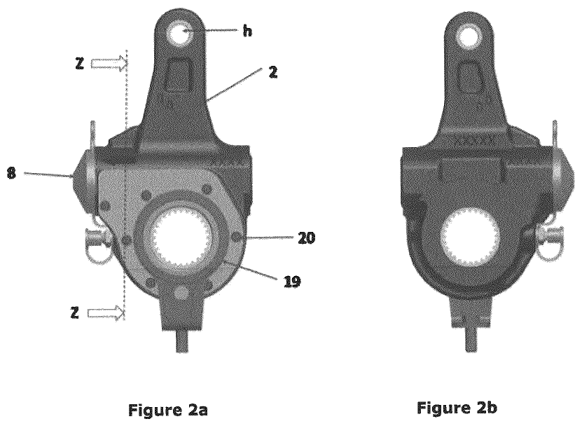

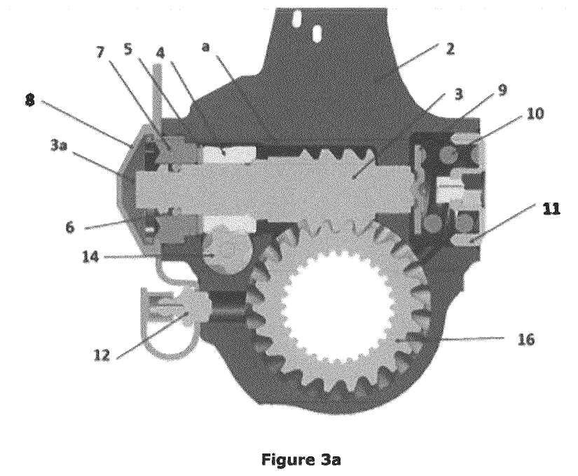

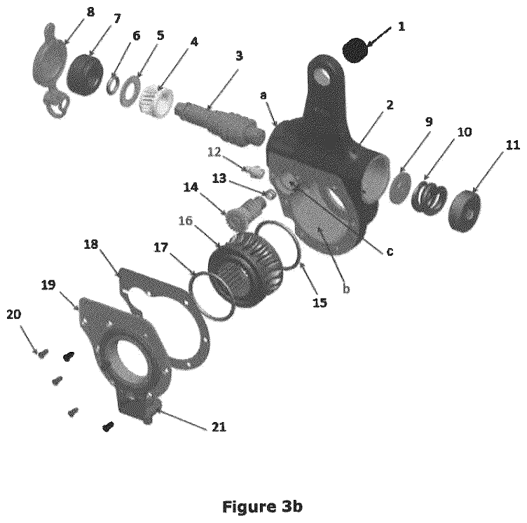

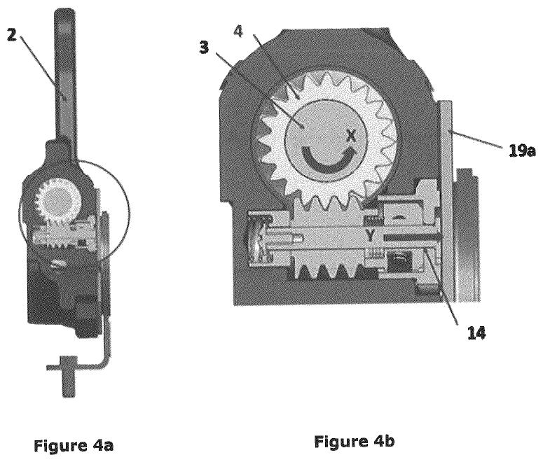

### DETAIL DESCRIPTION OF THE INVENTION

The conventional design's assembly will be explained first followed by its working principle, after which the invention and its working principle will be explained.

### Assembly of Conventional Design

FIG. 2 & FIG. 3 shows a conventional S-ASA assembly comprising a housing (2) which receives a worm shaft (3) in bore (a) of the housing (2) where the hexagon nut (3a) of the worm shaft (3) is in the left side of the assembly. A worm wheel (16) is assembled with 2 O-rings (17 & 15) in the bore (b) of the housing (2) which meshes with the worm shaft (3). A clutch worm gear (4) having serrations is inserted into the bore (a) from the left side of the housing (2) which meshes with the serrations of the worm shaft (3).

A bore (c) is present on the left side of the housing. A ratchet-pinion assembly (14) is inserted into bore (c) of the housing (2), the clutch worm screw (14a) of the ratchet pinion assembly (14) meshes with the clutch worm gear (4).

The top portion of the housing (2) is sealed by the gasket (18) and the cover plate assembly (19) as shown in FIG. 2. The cover plate assembly is screwed with the housing with 7 M4 screws (20).

A spring seat (9), heavy coil compression spring (10) and a spring retainer (11) is inserted from the right end into the bore (a) of the housing (2)

A bearing (5) is inserted into the housing bore (a) from the left side as shown in FIG. 2. An O-ring (6) is placed upon the groove of the worm shaft (3) then a bearing retainer (7) is inserted form the left side of the bore (a).

A grease nipple (12) is fitted to the housing (2). A protective cap (8) is fitted to the left end of the bore (a) which protects the S-ASA from water and dust. The protective cap (8) is locked with the grease nipple (12), this locking keeps the protective cap (8) from falling out of the assembly.

FIG. 1 shows a brake assembly (1L & 1R) for a drum type brake. S-ASA (1a) is assembled to the S-cam shaft (1b), a brake chamber (1c) is mounted onto the anchor bracket (1d). The S-ASA is connected to the brake chamber via the pin (1e), the pin (1e) is inserted into the hole (h) of S-ASA (1a). The control arm (21) of S-ASA (1a) is fixed to the anchor bracket via the screws (not shown in Figure).

S-ASA has two sides-front side and back side, this is shown in FIG. 2 where FIG. 2a represents the front side and FIG. 2b represent the back side of the S-ASA.

The back side of the S-ASA (1a) faces the brake chamber mounting bracket (1d) when installed in the brake assembly (1L) and the front side of the S-ASA (1a) faces the mounting bracket (1d) when installed in the brake assembly (1R).

### Working Principle of Conventional Design

There are two possible cases when brakes are applied—
1. The gap between the brake pads and inner diameter of the drum is within pre-defined limit. In this case no adjustment is required.
2. The gap between the brake pads and inner diameter of the drum is more than the pre-defined limit. In this case adjustment is required.

Both Cases Will be Discussed One by One

### Case-1

The control arm of S-ASA (1a) is anchored to a fixed member of vehicle (not shown in figure). The control gear wheel is assembled in such a way that there will be no relative rotational movement between control arm and control gear wheel.

When the brake is applied S-ASA (1a) rotates in the direction of arrow as shown in FIG. 2a. Control gear wheel does not rotate because the control arm is fixed. The pinion gear (14a) meshes with the control gear wheel (4) thus the pinion gear (14a) rotates due to the rotation of S-ASA (1a).

Before the brake application, there is a pre-set gap between pawl housing (14d) and control worm screw (14b). This gap is positioned by torsion spring (14e). This gap maintains a pre-defined clearance between brake lining and brake drum.

When slack adjuster is rotated, worm wheel rotates the camshaft and the gap between brake lining and drum starts reducing. When pawl housing (14d) rotates the gap between pawl housing (14d) and control worm screw (14b) closes.

If the gap between the brake linings and inner diameter of the drum is within pre-defined limit, the brake lining will touch the brake drum when pawl housing's gap closes with clutch worm screw (14b). In this condition no adjustment will be performed by S-ASA (1a).

### Case-2

If excess clearance is present between brake lining and drum then the brake lining will not touch the brake drum when pawl housing's gap closes with clutch worm screw. The S-ASA will continue to rotate and during further rotation the ratchet mechanism in the pinion assembly (14) will slip and take a new position.

### Slipping of the Ratchet Mechanism

FIG. 10 shows the ratchet mechanism. When excess gap is present between brake lining and drum the pinion gear (14a) continues to rotate in the anti-clockwise direction as shown by the arrow “x”. The clutch worm screw (14b) will not be able to rotate with the pinion gear (14a) due to friction present between clutch worm screw (14b) and clutch worm gear (4). This friction comes from the serrations of clutch worm gear (4) and worm shaft (3).The rotation of pinion gear (14a) causes the pawl pins (14c) to slip and engage in the new position.

When the brake lining starts to touch the brake drum then further rotation of S-ASA will increase the counter torque in the assembly and this torque will cause the disengagement of serrations between worm shaft (3) and clutch worm gear (4).

Now when the serrations are disengaged the friction force is no longer present to stop the clutch worm screw (14b) and thus it is now free to rotate.

This free rotation of clutch worm screw (14b) is essential to prevent the over-adjustment.

Reverse Stroke

When the brake is released S-ASA in FIG. 2a will start rotating in the clockwise direction. The pinion assembly will start rotating in the clockwise direction. The clutch worm screw (14b) will now rotate with the pinion gear (14a) due to the ratchet teeth which does not allow slip in this direction.

Further rotation of S-ASA will cause the brake lining and drum to separate. When brake lining disengages with the brake drum the counterforce is no longer present and the serrations of worm shaft (3) and clutch worm gear (4) is re-engaged.

The friction between clutch worm screw (14b) and clutch worm gear (4) is now restored due to serrations. Further rotation of S-ASA will cause the pinon gear (14b) to rotate in the clockwise direction but the clutch worm screw will not be rotating due to the restored friction. The pawl housing (14d) continues to rotate and the pre-set gap between pawl housing (14d) and clutch worm screw (14b) will be restored. This Pre-set gap is essential to control the ideal running clearance between brake drum and brake lining.

Further rotation of S-ASA will cause the clutch worm screw (14b) to rotate in the clockwise direction which in turn rotate the clutch worm gear (4). The clutch worm gear (4) will rotate the worm shaft (3) via serrations and the worm shaft (3) will now rotate the worm gear (16). The worm gear (16) in turn rotates the cam shaft (1b & 1g) and this rotation causes the reduction in excess gap present between brake lining and drum.

### The Invention

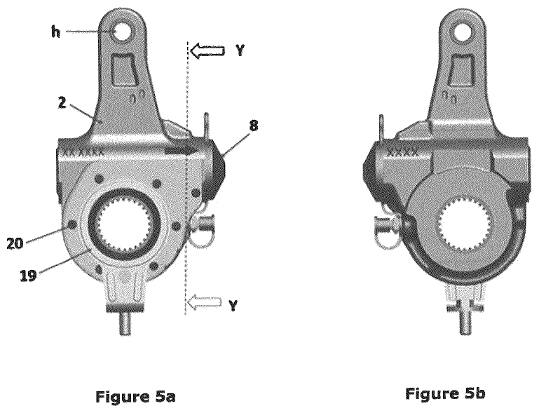

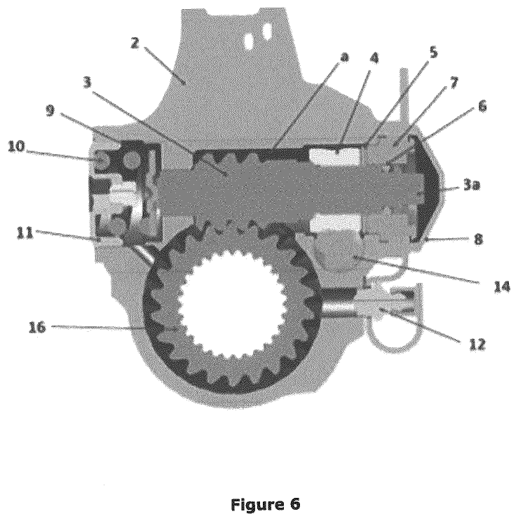

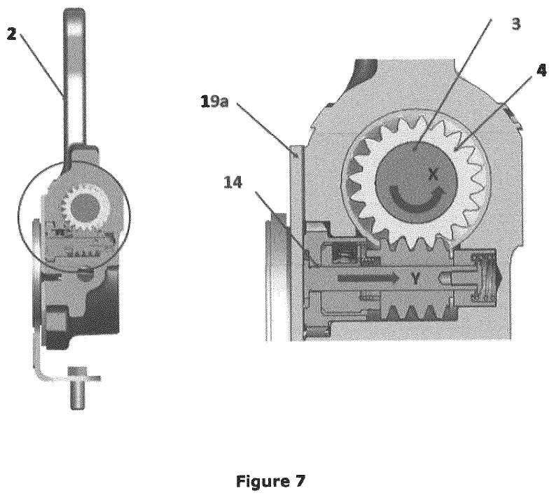

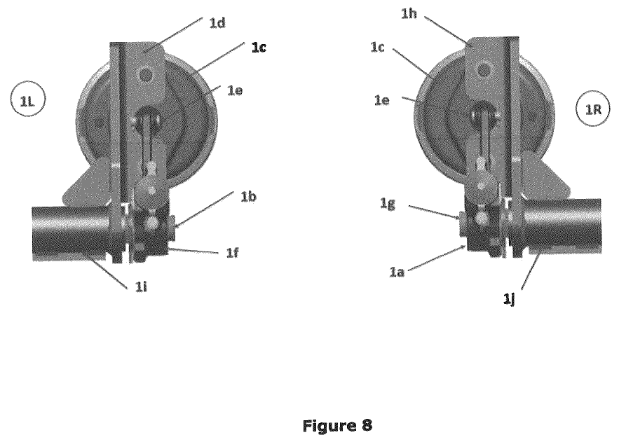

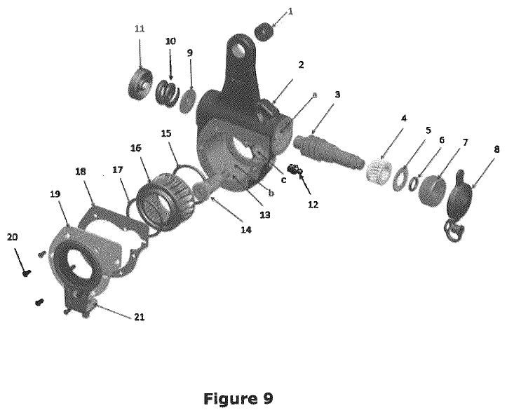

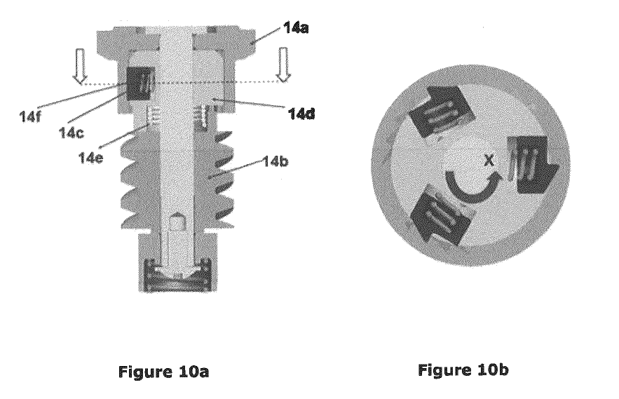

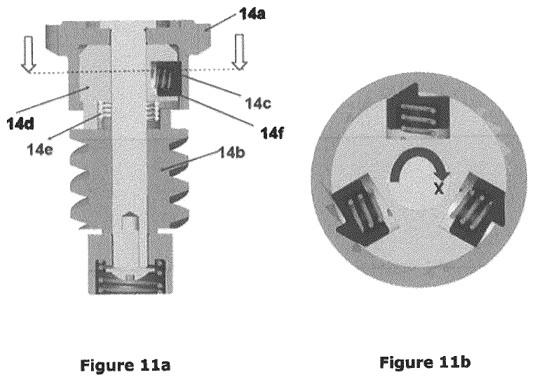

FIG. 5 & FIG. 6 shows a S-ASA assembly comprising a housing (2) which receives a worm shaft (3) in bore (a) of the housing (2) where the hexagon nut of the worm shaft (3) is in the right side of the assembly. A worm wheel (16) is assembled in the bore (b) of the housing (2) which meshes with the worm shaft (3). A clutch worm gear (4) is inserted into the bore (b) from the right side of the housing (2) which meshes with the serrations of the worm shaft (3).

A bore (c) is present on the right side of the housing. A ratchet-pinion assembly (14) is inserted into bore (c) of the housing (2), the clutch worm screw (14a) of the ratchet pinion assembly (14) meshes with the clutch worm gear (4).

The front portion of the housing (2) is sealed by the gasket (18) and the cover plate assembly (19) as shown in FIG. 9. The cover plate assembly is screwed with the housing with 7 M4 screws (20).

A bearing (5) is inserted into the housing bore (a) from the right side as shown in FIG. 9. An O-ring (6) is placed upon the groove of the worm shaft (3) then a bearing retainer (7) is inserted form the right side of the bore (a).

A grease nipple (12) is fitted to the housing (2). A protective cap (8) is fitted to the right end of the bore (a) which protects the S-ASA from water and dust. The protective cap (8) is locked with the grease nipple (12), this locking keeps the protective cap (8) from falling out of the assembly.

One can argue that changing the assembly direction is enough for assembling the slack adjuster in other side but if someone is changing the assembly direction of component parts then he/she has to change all the component parts suitably or the slack adjuster will not function. In other worlds all gear tooth direction has to be reversed.

The novelty lies here in designing a housing such that even if the direction of the assembly changes, there is minimal changes in only few components.

FIG. 8 shows a brake assembly (1L & 1R) for a drum type brake. A conventional S-ASA (1a) is assembled to the S-cam shaft (1g), a brake chamber (1c) is mounted onto the anchor bracket (1h). The S-ASA (1a) is connected to the brake chamber (1c) via the pin (1e), the pin (1e) is inserted into the hole (h) of S-ASA (1a). The control arm (21) of S-ASA (1a) is fixed to the anchor bracket (1h) via the screws.

The redesigned S-ASA (1f) is assembled to the S-cam shaft (1b), a brake chamber (1c) is mounted onto the brake chamber mounting bracket (1d). The S-ASA (1f) is connected to the brake chamber (1c) via the pin (1e), the pin (1e) is inserted into the hole (h) of S-ASA (1f). The control arm (21) of S-ASA (1f) is fixed to the vehicle chassis through anchor bracket (not shown in Figure).

S-ASA (1f) also has two sides-front side and back side, this is shown in FIG. 5 where FIG. 5a represents the front side and FIG. 5b represent the back side of the S-ASA (1f).

The front side of the S-ASA (1f) faces the brake chamber mounting bracket (1d) when installed in the brake assembly (1L) and the front side of the S-ASA (1a) faces the brake chamber mounting bracket (1h) when installed in the brake assembly (1R).

In this condition only back side of both S-ASA (1f) and S-ASA (1a) is directly exposed to the environment. The front side which has more potential leak path is protected by chamber mounting bracket (1d & 1h) and cam tube (1i & 1j) This assembly condition prevents the water or dust entry inside the S-ASA (1f) whereas S-ASA (1a) of brake assembly (1L) in FIG. 1, front side is directly exposed to environment.

### Working Principle of the Invention

There are two possible cases when brakes are applied
1. The gap between the brake pads and inner diameter of the drum is within pre-defined limit. In this case no adjustment is required.
2. The gap between the brake pads and inner diameter of the drum is more than the pre-defined limit. In this case adjustment is required.

### Both Cases Will be Discussed One by One

### Case-1

Refer FIGS. 5, 6, 7, 8, 9 & 11

In FIG. 8 The control arm of S-ASA (1f) is anchored to a fixed member of vehicle (not shown in Figure). The control gear wheel is assembled in such a way that there will be no relative rotational movement between control arm and control gear wheel.

When the brake is applied S-ASA (1f) rotates in the direction of arrow as shown in FIG. 5a. Control gear wheel does not rotate because the control arm is fixed. The pinion gear (14a) meshes with the control gear wheel ( ) thus the pinion gear (14a) rotates due to the rotation of S-ASA (1f).

Before the brake application there is a pre-set gap between pawl housing (14d) and control worm screw (14b). This gap is controlled by torsion spring (14e). This gap maintains a pre-defined clearance between brake lining and brake drum.

When slack adjuster is rotated, the worm wheel rotates the camshaft and the gap between brake lining and drum starts reducing. When pawl housing (14d) rotates the gap between pawl housing (14d) and control worm screw (14b) closes.

If the gap between the brake pads and inner diameter of the drum is within pre-defined limit, the brake lining will touch the brake drum when pawl housing's gap closes with clutch worm screw (14b). In this condition no adjustment will be performed by S-ASA (1f).

### Case-2

If excess clearance is present between brake lining and drum then the brake lining will not touch the brake drum when pawl housing's gap closes with clutch worm screw (14b). The S-ASA will continue to rotate and during further rotation the ratchet mechanism in the pinion assembly (14) will slip and take a new position.

### Slipping of the Ratchet Mechanism-

FIG. 11 shows the ratchet mechanism. When excess gap is present between brake lining and drum the pinion gear (14a) continues to rotate in the clockwise direction as shown by the arrow “x”. The clutch worm screw (14b) will not be able to rotate with the pinion gear (14a) due to friction present between clutch worm screw (14b) and clutch worm gear (4). This friction comes from the serrations of clutch worm gear (4) and worm shaft (3). The rotation of pinion gear (14a) causes the pawl pins (14c) to slip and engage in the new position.

When the brake lining starts to touch the brake drum then further rotation of S-ASA (1f) will increase the counter torque in the assembly and this torque will cause the disengagement of serrations between worm shaft (3) and clutch worm gear (4).

Now when the serrations are disengaged the friction force is no longer present to stop the clutch worm screw (14b) and thus it is now free to rotate. This free rotation of clutch worm screw (14b) is essential to prevent the over-adjustment.

### Reverse Stroke

When the brake is released S-ASA in FIG. 5a will start rotating in the anti-clockwise direction. The pinion assembly will also start rotating in the anti-clockwise direction. The clutch worm screw (14b) will now rotate with the pinion gear (14a) due to the ratchet teeth which does not allow slip in this direction. Further rotation of S-ASA will cause the brake lining and drum to separate. When brake lining disengages with the brake drum the counterforce in no longer present and the serrations of worm shaft (3) and clutch worm gear (4) is re-engaged.

The friction between clutch worm screw (14b) and clutch worm gear (4) is now restored due to serrations. Further rotation of S-ASA will cause the pinon gear (14b) to rotate in the anti-clockwise direction but the clutch worm screw will not be rotating due to the restored friction. The pawl housing (14d) continues to rotate and the pre-set gap between pawl housing (14d) and clutch worm screw (14b) will be restored. This Pre-set gap is essential to control the ideal running clearance between brake drum and brake lining.

Further rotation of S-ASA will cause the clutch worm screw (14b) to rotate in the anti-clockwise direction which in turn rotate the clutch worm gear (4). The clutch worm gear (4) will rotate the worm shaft (3) via serrations and the worm shaft (3) will now rotate the worm gear (16). The worm gear (16) in turn rotates the cam shaft (1b & 1g) and this rotation causes the reduction in excess gap present between brake lining and drum.

The Invention has Disclosed the Following Novel Features Such as

A self-setting automatic slack adjuster assembly as per FIG. 6
a. comprising a housing (2) which receives a worm shaft (3) in bore (a) of the housing (2) where the hexagon nut of the worm shaft (3) is in the right side of the assembly. A worm wheel (16) is assembled in the bore (b) of the housing (2) which meshes with the worm shaft (3). The bore (b) is perpendicular to the bore (a). The worm wheel (16) is inserted onto the S-cam shaft where S-cam shaft is coaxial with bore (b) of the housing.
b. A clutch worm gear (4) is inserted into the bore (a) from the right side of the housing (2) which meshes with the serrations of the worm shaft (3).
c. A bore (c) is present on the right side of the housing. A ratchet-pinion assembly (14) is inserted into bore (c) of the housing (2), the clutch worm screw (14b) of the ratchet pinion assembly (14) meshes with the clutch worm gear (4).
d. When the above slack adjuster is installed into the brake assembly, its cover plate assembly (19) faces the brake chamber mounting bracket and thus protected by direct exposure to the dust and water.

It has also disclosed a self-setting automatic slack adjuster assembly as detailed above.
a. A bore (c) is present on the right side of the housing. Which is parallel but not coaxial to the worm wheel bore (b).
b. A bore (c) is present on the right side of the housing. Which is perpendicular to the worm shaft bore (a).
c. A ratchet pinion assembly (14) with a one-way lock mechanism is inserted into the bore (c).
d. A ratchet pinion assembly (14) where one way lock mechanism slips in the clockwise direction.
e. A ratchet pinion assembly (14) where the pinion assembly pushes the housing (2) when rotated for servicing as shown in FIG. 7.
   The Essential Features Which has Been Disclosed, Described and Illustrated in this Inventions are

In one aspect the invention is for a self-setting Automatic Slack Adjuster assembly connected to brake chamber, comprising of a housing (2) with a plurality of bores (a, b and c), a grooved worm shaft (3) having a plurality of serrations is inserted in bore (a) of the housing (2) with a hexagon nut of the worm shaft arranged in the right side of the assembly, a worm wheel (16) is inserted in bore (b) of the housing (2) which worm wheel (16) meshes with the said worm shaft (3) mounted on bore (a), a clutch worm gear (4) also inserted on bore (b) of the housing (2) from the right side of the assembly, and such that worm gear meshes with serrations of worm shaft (3), a ratchet pinion assembly (14) having clutch worm screw (14a) is inserted into bore (c) positioned on the right side of the housing (2) and is such that the worm screw (14a) of ratchet pinion (14) meshes with the clutch worm gear (4), a cover plate assembly (19) alongwith a sealing gasket (18) is fixedly screwed onto the front portion of the housing (2) thereby sealing the front portion of housing, a bearing (5) is inserted into housing bore (a) from the right side of the assembly, a O-Ring (6) is placed onto the groove of the worm shaft (3), thereby sealing the right portion of housing, a bearing retainer (7) is inserted from the right side of bore (a), a grease nipple (12) is fitted to the housing (2) at sideway, a protective cap (8) is fitted to the right end of the bore (a), thereby protecting the assembly from water and dust, and the said protective cap (8) is located with grease nipple (12) thereby eliminating the cap (8) from dislocation.

This arrangement as per invention is characterized in that the cover plate assembly (19) faces the brake chamber mounting bracket and hence only back side of the assembly is exposed to environment attracting water and dust, unlike conventional assembly in which both sides are exposed to environment.

In another aspect, the invention also discloses that the bore (b) is perpendicular to bore (a), bore (c) is perpendicular to bore (a), bore (c) on the right side of housing is parallel to but not co-axial to the worm wheel bore (b), worm wheel (16) is inserted onto S-cam shaft where S-cam shaft is coaxial with bore (b) of the housing (2) and the ratchet pinion assembly (14) is one-way lock mechanism and inserted into bore (c).

In another aspect, the invention further also discloses that the one-way lock mechanism slips only in the clockwise direction and the ratchet pinion assembly (14) is adapted to push the housing (2) when rotated manually for servicing.

The examples and embodiments are provided only for the purpose of understanding and none of them shall limit the scope of the invention. All variants and modifications as will be envisaged by skilled person are within the spirit and scope of the invention.

1. A self-setting Automatic Slack Adjuster assembly connected to brake chamber, comprising of:
a. a housing (2) with a plurality of bores (a, b and c),
b. a grooved worm shaft (3) having a plurality of serrations is inserted in bore (a) of the housing (2) with a hexagon nut of the worm shaft arranged in the right side of the assembly,
c. a worm wheel (16) is inserted in bore (b) of the housing (2) which worm wheel (16) meshes with the said worm shaft (3) mounted on bore (a),
d. a clutch worm gear (4) also inserted on bore (b) of the housing (2) from the right side of the assembly, and such that worm gear meshes with serrations of worm shaft (3),
e. a ratchet pinion assembly (14) having clutch worm screw (14a) is inserted into bore (c) positioned on the right side of the housing (2) and is such that the worm screw (14a) of ratchet pinion (14) meshes with the clutch worm gear (4),
f. a cover plate assembly (19) alongwith a sealing gasket (18) is fixedly screwed onto the front portion of the housing (2) thereby sealing the front portion of housing,
g. a bearing (5) is inserted into housing bore (a) from the right side of the assembly,
h. a O-Ring (6) is placed onto the groove of the worm shaft (3), thereby sealing the right portion of housing,
i. a bearing retainer (7) is inserted from the right side of bore (a),
j. a grease nipple (12) is fitted to the housing (2) at sideway,
k. a protective cap (8) is fitted to the right end of the bore (a), thereby protecting the assembly from water and dust, and
l. the said protective cap (8) is located with grease nipple (12) thereby eliminating the cap (8) from dislocation,
wherein the cover plate assembly (19) faces the brake chamber mounting bracket and hence only back side of the assembly is exposed to environment attracting water and dust, unlike conventional assembly in which both sides are exposed to environment.

2. The self-setting Automatic Slack Adjuster assembly as claimed in claim 1 wherein bore (b) is perpendicular to bore (a).

3. The self-setting Automatic Slack Adjuster assembly as claimed in claim 1 wherein bore (c) is perpendicular to bore (a).

4. The self-setting Automatic Slack Adjuster assembly as claimed in claim 1 wherein bore (c) on the right side of housing is parallel to but not co-axial to the worm wheel bore (b).

5. The self-setting Automatic Slack Adjuster assembly as claimed in claim 1 wherein worm wheel (16) is inserted onto S-cam shaft where S-cam shaft is coaxial with bore (b) of the housing (2).

6. The self-setting Automatic Slack Adjuster assembly as claimed in claim 1 wherein the ratchet pinion assembly (14) is one-way lock mechanism and inserted into bore (c).

7. The self-setting Automatic Slack Adjuster assembly as claimed in claim 6 wherein the one-way lock mechanism slips only in the clockwise direction.

8. The self-setting Automatic Slack Adjuster assembly as claimed in claims 6 wherein the ratchet pinion assembly (14) is adapted to push the housing (2) when rotated manually for servicing.

9. The self-setting Automatic Slack Adjuster assembly as claimed in claim 7 wherein the ratchet pinion assembly (14) is adapted to push the housing (2) when rotated manually for servicing.
